(19) United States
(12) Patent Application Publication
(10) Pub. No.: US 2026/0241786 A1
(43) Pub. Date: Aug. 20, 2026

(54) METHOD FOR OPERATING A FUEL GAS TANK SYSTEM, AND CONTROL DEVICE

(71) Applicant: Robert Bosch GmbH, Stuttgart (DE)

(72) Inventors: Christian Schugger, Stuttgart (DE); Stephan Borges, Ludwigsburg (DE)

(21) Appl. No.: 19/164,879

(22) PCT Filed: Mar. 5, 2024
(86) PCT No.: PCT/EP2024/055690

§ 371 Date: Oct. 13, 2025

(30) Foreign Application Priority Data
Mar. 16, 2023 (DE) 10 2023 202 382.2

(51) Int. Cl. B60K 15/03

(52) U.S. Cl. CPC B60K 15/03006; B60K 2015/0321; B60K 2015/03427

(57) ABSTRACT

The invention relates to a method for operating a fuel gas tank system (1) with a plurality of fuel gas tanks (2) connected in parallel for storing fuel gas, preferably hydrogen, in which method, in order to avoid local freezing during the removal of fuel gas from a fuel gas tank (2), the temperature in the fuel gas tank (2) and/or in a removal path (4) which is connected to the fuel gas tank (2), in particular in the region of at least one functionally relevant component (3), is monitored and, if the temperature falls below a predefined lower limit value T_ref,
(a) the removal from the fuel gas tank (2) is stopped and a switchover is carried out to another fuel gas tank (2), and/or
(b) heat is fed in a targeted manner to the removal path (4) and/or the at least one functionally relevant component (3).

The invention also relates to a control device for carrying out steps of the method.

### BACKGROUND

The invention relates to a method for operating a fuel gas tank system. The invention further relates to a control device for carrying out the method.

Preferred areas of application are mobile fuel gas tank systems for fuel cell and/or gas vehicles, for example vehicles having a hydrogen internal combustion engine. The fuel gas may in particular be hydrogen or natural gas that is stored in a plurality of fuel gas tanks under high pressure connected in parallel. For hydrogen, the storage pressure is typically 700 to 350 bar.

When removing fuel gas, such as hydrogen, from a fuel gas tank of a fuel gas tank system, a temperature decrease occurs in the fuel gas tank and the involved valves. Moreover, the temperature in the fuel gas tank is influenced by further factors, in particular by heat transport events on the outer wall of the fuel gas tank as well as on the mounted fittings. In this respect, the current flow rate plays a role. For large agricultural machines, a low flow rate in the fuel gas tanks typically occurs due to the low travel speed and mounting conditions.

During operation of a fuel gas tank system, water may accumulate in the fuel gas tanks. This water, depending on whether it is liquid or vaporous, can also be discharged via the gas mass flow upon removal of the fuel gas and can precipitate along the removal path at the inner surfaces and fittings that it flows through. If the temperature drops further below the freezing point of water due to continuous removal of fuel gas, local ice formation can occur. This, in turn, can change the flow area and/or impair the operation of functionally relevant components.

### SUMMARY

The present invention is therefore concerned with the task of preventing ice formation on functionally relevant components of a fuel gas tank system with a plurality of fuel gas tanks.

To achieve this task, the method with the features of the disclosure is proposed. A control device for carrying out steps of the method according to the invention is also specified.

A method for operating a fuel gas tank system with a plurality of fuel gas tanks connected in parallel for storing fuel gas, preferably hydrogen, is proposed. In the method, in order to avoid local freezing during the removal of fuel gas from a fuel gas tank, the temperature in the fuel gas tank and/or in a removal path connected to the fuel gas tank, in particular in the region of at least one functionally relevant component, is monitored, and if the temperature falls below a predefined lower limit value T_ref,
(a) the removal from the fuel gas tank is stopped and a switchover is carried out to another fuel gas tank, and/or
(b) heat is fed in a targeted manner to the removal path and/or the at least one functionally relevant component.

By switching to a different fuel gas tank when below the lower temperature limit value T_ref, further cooling caused by the gas mass flow can be prevented so that freezing does not occur in the removal path. Alternatively, or in addition, icing in the removal path can be prevented by a targeted heat supply.

Preferably, both measures are combined so that after switching to the other fuel gas tank, heat is fed in a targeted manner to the removal path connected to the first fuel gas tank in order to raise the temperature as quickly as possible again to a value above T_ref. This is because if the temperature in the other fuel gas tank or in the removal path connected to the other fuel gas tank also falls below the lower temperature limit value T_ref within a short time, a new switchover could be necessary. The first fuel gas tank would then be available again.

The lower temperature limit value T_ref is preferably selected such that there is still no risk of freezing when the limit value is reached. This ensures that no flow area is blocked by ice formation and that the function of the at least one functionally relevant component is ensured.

In order to keep the additional energy demand as low as possible, it is proposed, in a further development of the invention, that the heat supply in step (b) is ended when a temperature increase of x [K] over the lower temperature limit value (T_ref) is reached. For this purpose, an upper temperature limit value may be specified. If the temperature in the fuel gas tank and/or the removal path exceeds this limit value, the targeted heat supply is ended.

Advantageously, in step (b), the heat is generated using an electrical heating device and/or an electrical heating element. These can be controlled to generate heat. Furthermore, they may be integrated into the fuel gas tank system in a space-saving manner. Preferably, the electrical heating device and/or the electrical heating element is arranged on the removal path and/or on the at least one functionally relevant component.

Furthermore, preferably, temperature monitoring is carried out with the aid of at least one temperature sensor arranged on the fuel gas tank, the removal path, and/or on the at least one functional component. Ideally, the temperature is monitored at multiple defined locations in the fuel gas tank system. That is, at least one temperature sensor is present at each of these locations.

With the aid of the plurality of temperature sensors, not only the temperature in a fuel gas tank and/or the removal path is preferably monitored, but in all fuel gas tanks and/or removal paths. In order to be able to compare the temperatures, the temperature sensors should be placed at the same locations on the respective fuel gas tanks and/or removal paths.

Preferably, the temperature is monitored in the region of at least one tank valve of a fuel gas tank. A tank valve is typically not a single valve, but a valve assembly having a plurality of valves and other safety devices integrated within its housing. The tank valve accordingly comprises a plurality of functionally relevant components. As a result, the temperature monitoring may be performed with fewer temperature sensors and thus more efficiently. Since typically each fuel gas tank of a tank system has its own tank valve, preferably the temperature is monitored in the region of all tank valves of the fuel gas tank system.

Additionally, preferably, in step (b), the heat is fed in a targeted manner to the region of at least one tank valve of a fuel gas tank. As a tank valve typically comprises a plurality of functionally relevant components, the number of electrical heating devices and/or electrical heating elements may be reduced so that the targeted supply of heat can be designed more efficiently.

To achieve the above-mentioned task, a control device for a fuel gas tank system is also proposed. The control device is configured to carry out steps of a method according to the invention.

For example, the control device may be used to analyze the sensor data of at least one temperature sensor for monitoring the temperature in a fuel gas tank and/or a removal path connected to the fuel gas tank. Depending on the result of the analysis, the control device may then be used to switch to another fuel gas tank when removing fuel gas from one fuel gas tank. For this purpose, the predefined lower temperature limit value T_ref is preferably stored in the control device. If the control device has the temperature data of all fuel gas tanks and/or removal paths, the control device can be used to determine the respective fuel gas tank or removal path that is warmest, so that it can be switched to it if required. Using the control device, the sequence of the fuel gas tanks, in particular the sequence for controlling the tank valves connected to the fuel gas tanks, can thus be determined when removing fuel gas.

### BRIEF DESCRIPTION OF THE DRAWINGS

The method according to the invention and its advantages are explained in more detail below with reference to the accompanying drawings. Shown are:

FIG. 1 a schematic illustration of a fuel gas tank system which can be operated according to the method according to the invention,

FIG. 2 a graph illustrating the tank temperature profile with continuous removal of fuel gas and a constant ambient temperature,

FIG. 3 a graph illustrating the tank temperature profile with continuous removal of fuel gas and a changing ambient temperature due to varying vehicle speeds; and

FIG. 4 Progression of a possible tank valve and heating device actuation sequence.

### DETAILED DESCRIPTION

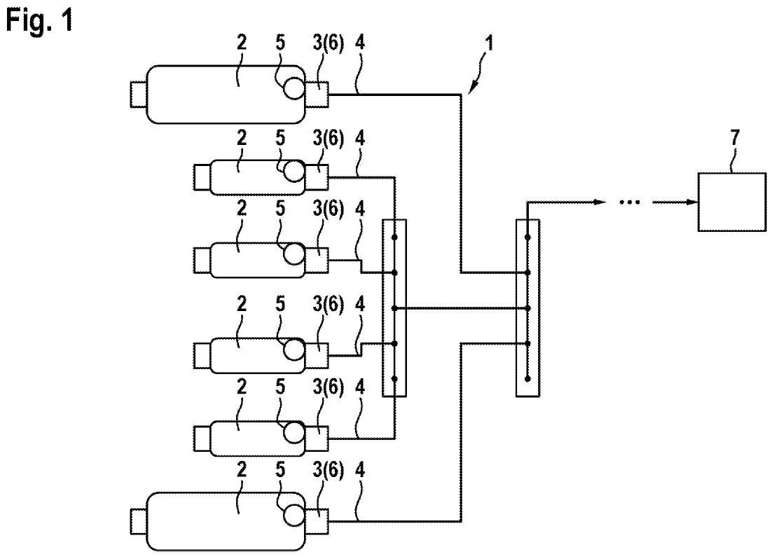

FIG. 1 shows a simplified illustration of a fuel gas tank system 1 with a plurality of fuel gas tanks 2. The fuel gas tank system 1 shown serves in this case to supply a fuel cell stack 7 with fuel gas, preferably hydrogen. Alternatively, with the aid of the fuel gas tank system 1, a hydrogen internal combustion engine may also be supplied with hydrogen.

Each fuel gas tank 2 is connected to a tank valve 6, in which at least one functionally relevant component 3, in particular a valve, is integrated for the removal of fuel gas from the fuel gas tank 2. A removal path 4 accordingly leads through tank valve 6, wherein the removal paths 4 of the plurality of fuel gas tanks 2 are progressively joined. The tank valves 6 of the fuel gas tank system 1 shown also each have a temperature sensor 5 integrated, by means of which the temperature in the respective fuel gas tank 2 is monitored.

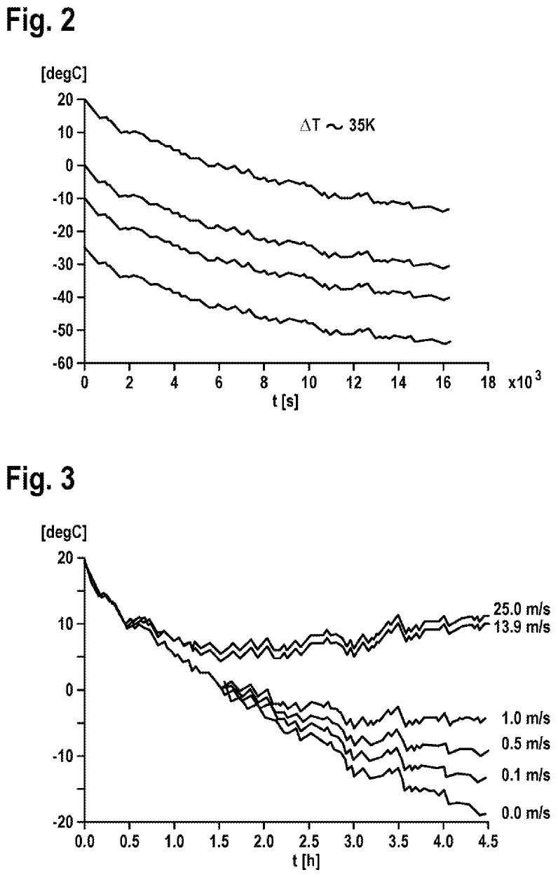

As exemplarily shown in FIG. 2, when fuel gas is removed from a fuel gas tank 2, the temperature in the fuel gas tank 2 decreases. Regardless of the respective starting temperature, which in FIG. 2 is shown once at 20° C., once at 0 ° C., once at −10° C. and once at 25° C., a temperature drop of about 35 K is achieved over the specified period of time. That is to say, the temperature falls below the freezing point of water so that water brought along with the gas flow during removal of the fuel gas can condense and freeze at the internal surfaces in the removal path 4. If this happens in the region of a functionally relevant component 3, the function of this component 3 is no longer ensured.

The ambient temperature has an impact on the temperature in fuel gas tank 2, and in the case of a vehicle this ambient temperature is in particular influenced by the speed of the vehicle, this connection can be seen in FIG. 3.

By means of the method according to the invention, freezing in the removal path can be avoided during the removal of fuel gas from a fuel gas tank 2. For this purpose, the temperature in the fuel gas tank 2 or in the tank valves 6 is recorded with the aid of temperature sensors 5. If the temperature in a fuel gas tank falls below a predefined lower temperature limit T_ref due to the removal of fuel gas, removal from that fuel gas tank 2 is stopped and the tank valve 6 of another fuel gas tank 2 is actuated, in which tank the temperature is above the lower temperature limit T_ref. That is to say, there is a switchover to the other fuel gas tank 2, and the fuel gas is now extracted from that fuel gas tank 2.

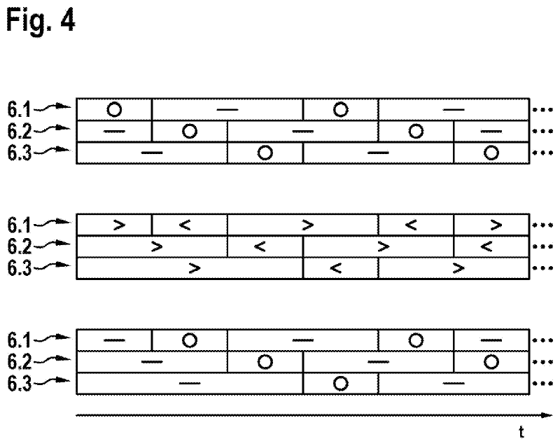

FIG. 4 shows, by way of example, a control sequence for three tank valves 6.1, 6.2, 6.3, which are controlled alternately. The circle icon in the first three rows of FIG. 4 means that the respective tank valve or the removal path is open; the dashed icon means that the respective tank valve or the removal path is closed.

The next three rows indicate the temperatures measured in the fuel gas tanks connected to the tank valves using a temperature sensor. If the temperature is above T_ref the tank valve is open. If it is below it, the tank valve is closed.

The last three rows respectively reflect the state of a heating device connected to the tank valves, by means of which heat can be fed in a targeted manner to the tank valves. If the temperature is below T_ref, the heating device is activated (circle symbol) and the tank valve is supplied with heat in a targeted manner via the heating device. If the temperature is above T_ref, the heating device is deactivated (dashed icon).

1. A method for operating a fuel gas tank system (1) with a plurality of fuel gas tanks (2) connected in parallel for storing fuel gas in which method, in order to avoid local freezing during the removal of fuel gas from a fuel gas tank (2), the temperature in the fuel gas tank (2) and/or in a removal path (4) which is connected to the fuel gas tank (2) is monitored and, if the temperature falls below a predefined lower limit value T_ref,
(a) the removal from the fuel gas tank (2) is stopped and a switchover is carried out to another fuel gas tank (2), and/or
(b) heat is fed in a targeted manner to the removal path (4) and/or the at least one functionally relevant component (3).

2. The method according to claim 1,
wherein, in step (b), the heat supply is ended when a temperature increase of x [K] above the lower temperature limit value (T_ref) is reached.

3. The method according to claim 1,
wherein, in step (b), the heat is generated using an electrical heating device and/or an electrical heating element, which is preferably arranged on the removal path (4) and/or on the at least one functionally relevant component (3).

4. The method according to claim 1,
wherein the temperature monitoring is carried out with the aid of at least one temperature sensor (5) arranged on the fuel gas tank (2), on the removal path (4) and/or on the at least one functional component (3).

5. The method according to claim 1,
wherein the temperature in the region of at least one tank valve (6) of a fuel gas tank (2) is monitored.

6. The method according to claim 1,
wherein, in step (b), the heat is fed in a targeted manner in the region of at least one tank valve (6) of a fuel gas tank (2).

7. A control device configured to control operation of a fuel gas tank system (1), where the fuel gas tank system includes a plurality of fuel gas tanks (2) connected in parallel for storing fuel gas, by:
to avoid local freezing during the removal of fuel gas from a fuel gas tank (2), monitoring the temperature in the fuel gas tank (2) and/or in a removal path (4) which is connected to the fuel gas tank (2) and, if the temperature falls below a predefined lower limit value T_ref,
controlling stopping the removal from the fuel gas tank (2) and switching over to another fuel gas tank (2), and/or
controlling heating in a targeted manner to the removal path (4) and/or the at least one functionally relevant component (3).
